(19) United States
(12) Patent Application Publication
(10) Pub. No.: US 2022/0382556 A1
(43) Pub. Date: Dec. 1, 2022

(54) METHOD AND APPARATUS FOR A LOGIC-BASED FILTER ENGINE

(71) Applicant: Rockwell Collins, Inc., Cedar Rapids, IA (US)

(72) Inventors: Edward C. Tubbs, Cedar Rapids, IA (US); Sean Nichols, Marion, IA (US); Jonathon C. Skarphol, Robins, IA (US); Sean Jarrard, Cedar Rapids, IA (US); Brian R. Roggendorf, Marion, IA (US); Ronald Luse, Marion, IA (US); James A. Marek, Anamosa, IA (US)

(21) Appl. No.: 17/331,237

(22) Filed: May 26, 2021

(51) Int. Cl. G06F 9/38; G06F 9/54; G06N 5/02

(52) U.S. Cl. CPC G06F 9/3893; G06F 9/544; G06F 9/545; G06F 9/546; G06N 5/025

(57) ABSTRACT

A cross-domain guard is disclosed that includes a field programmable gate array (FPGA). The FPGA includes a rule database containing one or more rules, a memory interconnect configured to send control data or rule processing data, media access control logic, and a plurality of filter engines configured to receive an incoming message and generate a processed message. Each of the plurality of filter engines may contain a message processing allocation element configured to receive and distribute the incoming message, and a plurality of rule processor kernels. Each of the plurality of rule processor kernels includes a rule processor kernel control element, a plurality of data operator kernels configured to perform a data comparison operation, a ternary lookup table processor configured to perform a logic operation based upon a result of the data comparison operation, and a processed message arbiter. A method for filtering incoming messages is also disclosed.

### BACKGROUND

Communication networks often rely on system components having differing levels of security. For example, military aircraft communication networks may include several security levels, such as classified and unclassified domains, for operating and/or accessing information associated with aircraft system components. In another example, commercial aircraft communication networks may include components of systems with differing security levels that are pilot-specific (e.g., for pilot to air traffic control communication) and passenger-specific (e.g., for passengers pairing a personal electronic device with an aircraft entertainment system). Preventing the inappropriate transfer of data between componentry having differing security levels is important for maintaining the overall integrity of the communication network.

Cross-domain solutions (CDSs) are network information assurance systems, typically software based, that provide a controlled interface to manually or automatically enable or restrict the access or transfer of information between two or more security domains based on a predetermined security policy. CDSs are designed to enforce domain separation and content filtering, while allowing a trusted network domain to exchange information with other domains without introducing the potential for security threats that could normally come with network connectivity.

One core element of the CDS is a filter engine which applies user-defined rules to incoming messages and/or data. The application of these rules to incoming data is often computationally complex, causing data bottlenecks within the network. As networking systems increase in data transfer capacity, current CDS architectures may not attain throughput and latency requirements. For example, legacy CDSs using software-based filter engines may not meet current requirements for information sharing in multidomain or Joint All-Domain Command and Control (JADC2) environments. Therefore, it is desirable to provide a CDS having increased capacity, and lower latency than conventional approaches.

### SUMMARY

A system is disclosed. In one or more embodiments, the system includes a cross-domain guard is disclosed. In one or more embodiments, the cross-domain guard includes a field programmable gate array. In one or more embodiments, the field programmable gate array includes a rule database containing one or more rules. In one or more embodiments, the field programmable gate array further includes a memory interconnect configured to send at least one of control data or rule processing data. In one or more embodiments, the field programmable gate array further includes media access control logic. In one or more embodiments, the field programmable gate array further includes a plurality of filter engines configured to receive an incoming message and generate a processed message. In one or more embodiments, one or more of the plurality of filter engines includes a message processing allocation element configured to receive and distribute the incoming message. In one or more embodiments, the plurality of rule processor kernels further includes a processed message arbiter.

In some embodiments of the system, the one or more of the plurality of filter engines further includes a plurality of rule processor kernels. In one or more embodiments, one or more of the plurality of rule processor kernels includes a rule processor kernel control element. In one or more embodiments, the one or more of the plurality of rule processor kernels includes a plurality of data operator kernels configured to perform a data comparison operation. In one or more embodiments, the one or more of the plurality of rule processor kernels further includes a ternary lookup table processor configured to perform a logic operation based upon a result of the data comparison operation.

In some embodiments of the system, one or more of the plurality of data operator kernels comprises a data operator kernel control. In some embodiments of the cross-domain guard, the one or more data operator kernels includes an instruction memory configured to store the one or more rules. In some embodiments of the cross-domain guard, the one or more data operator kernels includes a data fetch engine configured to fetch message data. In some embodiments of the cross-domain guard, the one or more data operator kernels includes an operator function element configured to perform the data comparison operation based on the one or more rules and message data. In some embodiments of the cross-domain guard, the one or more data operator kernels includes a result write element.

In some embodiments of the system, the plurality of filter engines are configured to operate independently and in parallel to each other.

In some embodiments of the system, the plurality of rule processor kernels are configured to operate independently and parallel to each other.

In some embodiments of the system, the plurality of data processor kernels are configured to operate independently and parallel to each other.

In some embodiments of the system, the rule processor further comprises a message buffer.

In some embodiments of the system, one or more of the plurality of rule processor kernels further comprise a data dictionary buffer configured to store constants used for rule processing.

In some embodiments of the system, the system further comprises a high-level component and a low-level component.

In some embodiments of the system, the system further comprises a communication network.

A method for filtering an incoming message between network components having different privileges is also disclosed. In one or more embodiments, the method includes fetching one or more rules from a rule database. In one or more embodiments, the method further includes receiving the incoming message. In one or more embodiments, the method further includes distributing the rule to one or more rule processor kernels. In one or more embodiments, the method further includes distributing the incoming message to one or more rule processor kernels. In one or more embodiments, the method further includes distributing the incoming message and the rule to one or more data operator kernels. In one of more embodiments, the method further includes performing a data checking operation. In in one or more embodiments, the method further includes performing a logic operation upon a result of the data checking operation. In one or more embodiments, the method further includes sending a processed message based on a result of the logic operation.

In some embodiments of the method, the method is performed by a cross-domain guard.

In some embodiments of the method, performing the data checking operation and performing the logic operation is performed via a field programmable gate array.

In some embodiments of the method, the different privileges are configured as different security levels.

In some embodiments of the method, the network components are configured as a high-level component and a low-level component.

In some embodiments of the method, the performing the data checking operation is executed in parallel.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1A is a block illustration of a communication network comprising a cross-domain solution, in accordance with one or more embodiments of the disclosure;

FIG. 1B is a block diagram illustrating a cross domain solution, in accordance with one or more embodiments of the disclosure;

FIG. 1C is a block diagram illustrating a cross domain solution, in accordance with one or more embodiments of the disclosure;

FIG. 1D is a block diagram illustrating a cross domain solution, in accordance with one or more embodiments of the disclosure;

FIG. 1E is a block diagram illustrating a detailed view of the cross-domain guard and associated field programmable gate array (FPGA), in accordance with one or more embodiments of the disclosure;

FIG. 2 is a block diagram illustrating a top-tier view of the filter engine, in accordance with one or more embodiments of the disclosure;

FIG. 3 is a block diagram illustrating a rule processor kernel, in accordance with one or more embodiments of the disclosure.

FIG. 4 is a block diagram illustrating a data operator kernel, in accordance with one or more embodiments of the disclosure.

FIG. 5 is a flowchart illustrating a method for filtering incoming messages between network component having different security levels, in accordance with one or more embodiments of the disclosure.

FIG. 6 is a block diagram is a rule data base structure utilized by the filter engine, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

A cross-domain solution (CDS) is disclosed. The CDS includes a cross domain guard configured as a field programmable gate array (FPGA) processor operating a plurality of filter engines in parallel for performing CDS-associated content filtering. A three-tiered architecture is programmed within the FPGA, resulting in scalable, distributed processing of data having lower latency and higher throughput than current software-based methods. The FPGA is designed to implement processing elements capable of applying any rule to any message of any content organization. Individual processing elements are implemented for each type of data operator, having a defined instruction set architecture (ISA) designed to minimize bubble cycles. The FPGA design also implements individual processing elements for processing arbitrary logic functions, which each vary based on an applied rule. The implementation of the cross-domain guard is table driven, rather than format driven, which results in fewer changes being made to the core of the CDS when rules are modified, as hard-coded rule changes (e.g., format driven changes) are not made within the logic. This results in increased speed, throughput, and energy efficiency over software-implemented cross-domain guards. A method is also disclosed using the described CDS, wherein an incoming message is filtered between network components having different privileges (e.g., security levels).

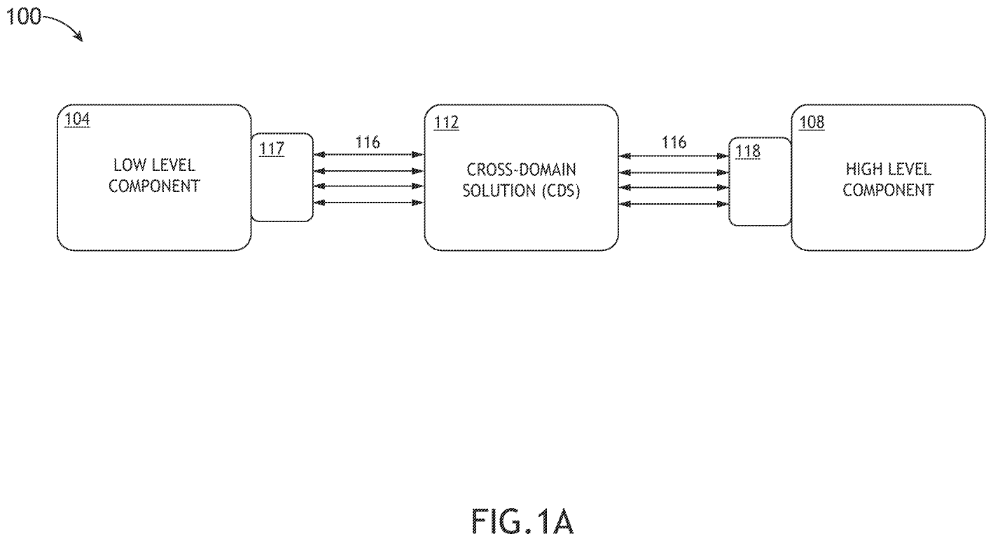

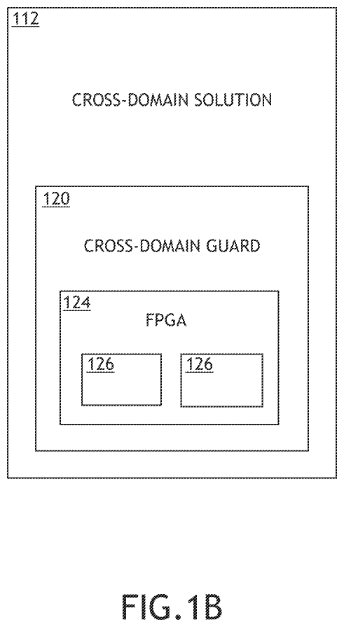

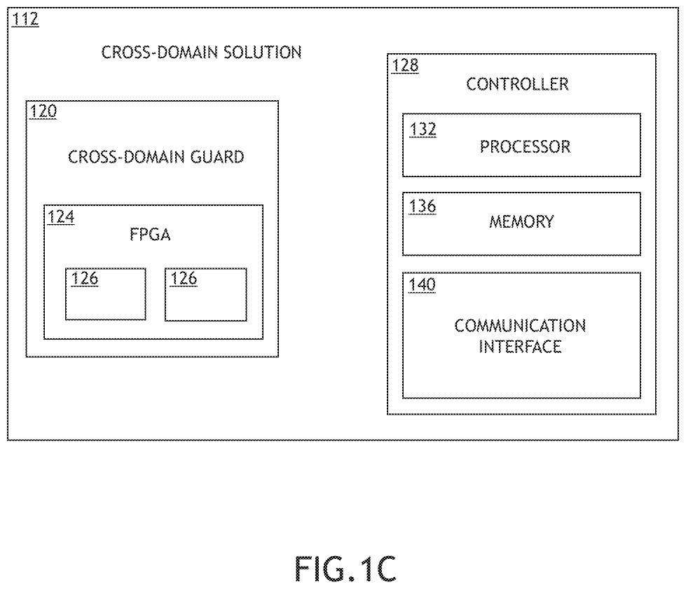

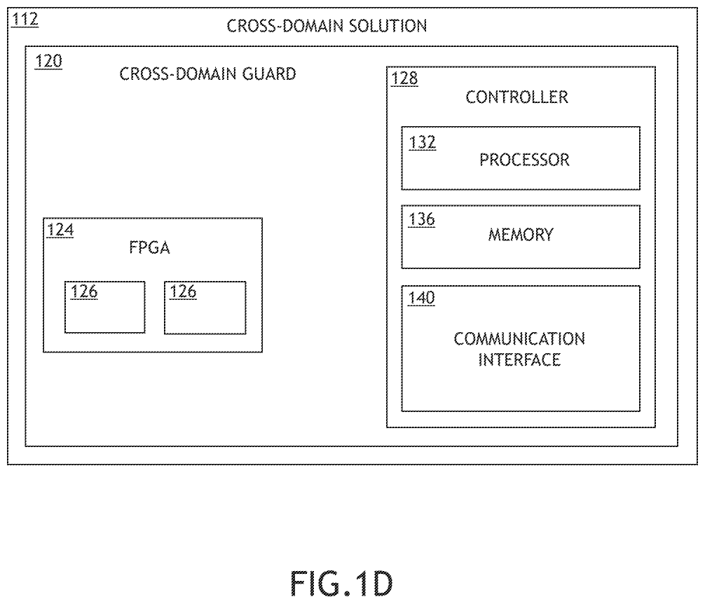

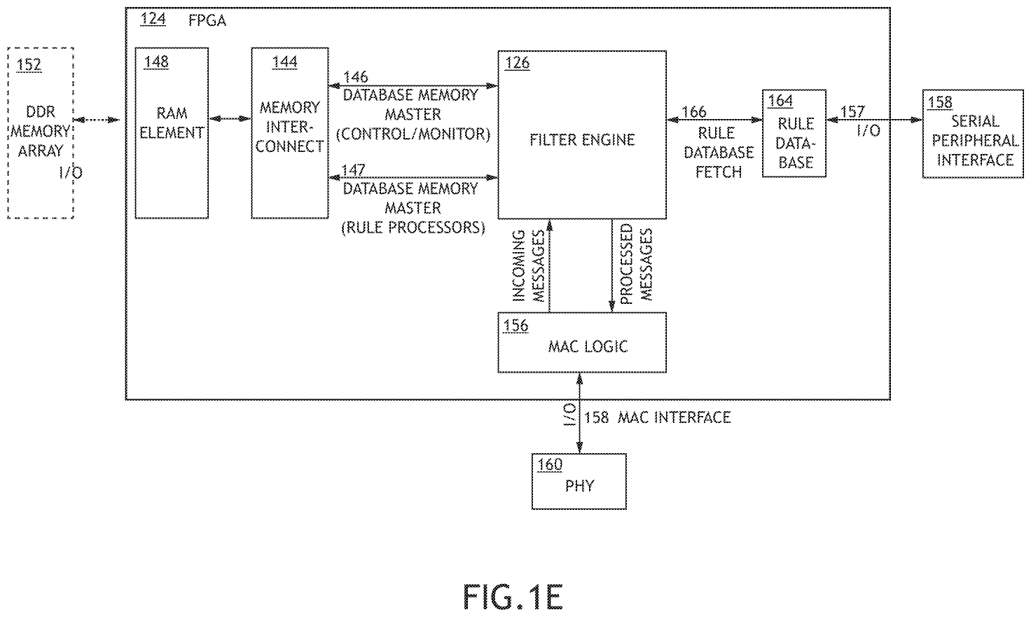

FIG. 1A is a block illustration of a communication network 100, in accordance with one or more embodiments of the disclosure. The communication network 100 may include any type of communication structure between two or more entities. For example, the communication network 100 may be configured as a military aircraft communication system, allowing communication to occur between one or more aircraft and a base station. In another example, the communication network 100 may be configured as a commercial and/or civilian communication system, connecting pilots with air controllers and/or passengers. In another example, the communication network 100 may be configured as a business computer network comprising a plurality of desktop computers. In another example, the communication network 100 may be configured as a network of embedded computers.

The communication network 100 may be configured to transfer any type of information or data including but not limited to tactical data, commercial/business data/documentation, personal data/documentation, and the like. For example, the communication network 100 may be configured to send and/or receive position coordinates of an aircraft. In another example, the communication network 100 may be configured to send and/or receive PDF files containing privacy-sensitive personal medical information.

In some embodiments, the communication network 100 comprises separate enclaves or domains that are differentiated by defined privileges. For example, the communication network 100 may comprise enclaves and/or domains that are separated by differing levels of security (e.g., a privilege configured as a security level). In another example, the communication network 100 may comprise enclaves and/or domains that are separated or isolated by function. For instance, the communication network 100 of an aircraft may have separate enclaves for flight critical functions and passenger entertainment functions, with each enclave having a different set of privileges. In another instance, for a communication network 100 incorporated into a tactical simulation training system (e.g., a ‘red’ team versus a ‘blue’ team), the communication network 100 may include separate enclaves for the red team and blue team, with each enclave having a different set of privileges.

The communication network 100 includes at least two components that are in communication with each other having different predetermined security levels. For example, the communication network 100 may include a low-level component 104 and a high-level component 108 configured to have one-way or two-way communication with each other. The low-level component 104 may be configured as a network component having a less sensitive or less trusted security domain than the high-level component 108. For example, in a commercial aircraft, the high-level component 108 may be configured as a high-security level flight computer, whereas the low-level component 104 may be configured as a passenger smartphone attempting to communicate with the high-security level flight computer.

The communication network 100 may include any number or any range of numbers of low-level components 104 and high-level components 108. For example, the communication network 100 may include a single low-level component 104 and a single high-level component 108 (e.g., as shown in FIG. 1). In another example, the communication network 100 may include one or more high-level components 108 and two or more low-level components 104. For instance, the communication network 100 may include any number of low-level components 104 within a range of two to ten low-level components 104, any number of low-level components 104 within a range of ten to 100 low-level components 104, and/or any number of low-level components 104 within a range of 100 to 1000 low-level components 104. In another example, the communication network 100 may include one or more low-level components 104 and two or more high-level components 108. For instance, the communication network 100 may include any number of high-level components 108 within a range of two to ten high-level components 108, any number of high-level components 108 within a range of ten to 100 high-level components 108, and/or any number of high-level components 108 within a range of 100 to 1000 low-level components 108. The communication network 100 may also be scalable to any number of low-level components 104 and any number of high-level components.

The communication network 100 may include any type of low-level component 104 or high-level component 108. For example, the communication network 100 may include low-level components 104 and/or high-level components 108 for military applications, military-based security domains, and/or enclaves within military-based security domains. For instance, the communication network 100 may be configured with low-level components 104 and/or high-level components 108 that include or are similar to Special Access Program (SAP)/Special Access Required (SAR) components. In particular, the communication network 100 may be configured with low-level components 104 and/or high-level components 108 that include or are similar to Top Secret (TS), Secret (S), Confidential (C), Unclassified (U), TS/SAR1, TS/SAR2, S/SAR1, S/SAR2, S/NATO, or any other combo of SAP/SAR or caveats. In another example, the communication network 100 may include low-level components 104 and/or high-level components 108 for non-military applications. For instance, the communication network 100 may include low-level components 104 and/or high-level components 108 (e.g., enclave attributes) purposed for Design Assurance Levels (DAL)/Item Development Assurance Levels (IDAL). In particular, the communication network 100 may include low-level components 104 and/or high-level components 108 (e.g., enclave attributes) purposed for (DAL)/(IDAL) in a Federal Aviation Administration context.

In some embodiments, the communication network includes a cross-domain solution (CDS) 112 configured to enable and/or restrict the access or transfer of information between the low-level component 104 and the high-level component 108. For example, the CDS 112 may be configured to restrict access and/or transfer of highly confidential information between the high-level component 108 to the low-level component 104. For instance, the CDS 112 may prevent the transfer of confidential patient medical records from the high-level component 108 (e.g., a hospital database) to the low-level component 104 (e.g., a smartphone of a user not having security clearance to receive the documents). In another example, the CDS 112 may be configured to restrict the transfer of potentially damaging software (e.g., viruses, malware) between the high-level component 108 and the low-level component. In another example, the CDS 112 may be configured to restrict access of the low-level component 104 to the high-level component 108. For example, on a commercial flight, the CDS 112 may prevent a passenger having access to an aircraft entertainment system (e.g., a low-level component 104) from accessing the flight management system. The CDS 112 may be communicatively coupled to the low-level component 104 and the high-level component 108 via a low-level component interface 117 and a high-level component interface 118, respectively. The low-level component 104 may include any number or type of low-level component interface 117 (e.g., the number of low-level component interfaces 117 is arbitrary). Likewise, the high-level component 108 may include any number or type of high-level component interface 118 (e.g., the number of low-level component interfaces 118 is arbitrary).

Communication between the low-level component 104, the high-level component 108 and the CDS 112 may be maintained via one or more buses 116. The one or more busses may be configured as any type of computer bus including but not limited to a peripheral component interconnect express (PCIe), a high-speed serial computer expansion bus standard. The use of PCIe or other high-speed computer buses allow the computer network 100 to send data to and from the CDS via high data rates. For example, under low-power conditions, data transfer to and/or from the CDS 112 may reach 10 Mbps or higher. In another example, under high power conditions, data transfer to and/or from the CDS 112 may reach 10 Gbps or higher.

It should be understood that the CDS 112 may be configured as a system. It should also be understood that the CDS 112, the low-level component 104, and/or the high-level component together may be configured as a system. It should also be understood that the communication network 100, the CDS 112, the low-level component 104, and/or the high-level component together may be configured as a system. Therefore, the above description should not be interpreted as a limitation of the present disclosure, but merely an illustration.

FIG. 1B-1D are block diagrams illustrating the CDS 112, in accordance with one or more embodiments of the disclosure. The CDS 112 includes a cross-domain guard 120 configured as a core security-enforcing mechanism intended to provide cross domain security functionality. For example, the cross-domain guard 120 may provide a filtering function for the CDS 112, ensuring secure flow of data between the low-level component 104 and the high-level component 108.

In embodiments, the cross-domain guard 120 includes a field programmable gate array (FPGA) 124 programmed with one or more filter engines 126, configured to provide at least a portion of the data filtering function of the CDS 112. The FPGA 124 may be configured as any type of programmable processor including but not limited to SRAM FPGAs, antifuse FPGAs, flash FPGAs, and hybrid flash/SRAM FPGAs. The FPGA 124 may be configured to include one or more cores (e.g., IP core, embedded core, processor core, Digital Signal Processor (DSP) core, or analog core). The FPGA 124 may be programmed with any number of filter engines 126. For example, the FPGA 124 may be programmed to include ten or more filter engines 126. In another example, the FPGA 124 may be programmed to include 100 or more filter engines. In another example, the FPGA 124 may be programmed to include 1000 or more filter engines 126.

In some embodiments, the CDS 112 is configured to manage and/or audit CDS processes. For example, the CDS 112 may be configured to audit previously filtered content to ensure that the CDS 112 is operating within National Cross Domain Strategy Management Office (NCDSMO) standards. For example, the CDS 112 may be configured to determine whether the CDS 112 is operating within Raise-The-Bar (RTB) guidelines. In another example, the CDS 112 may be configured to assess filter success rates, and/or modify operating parameters if filter success rates fall below standards.

In embodiments, one or more functions of the CDS 112 and/or the cross-domain guard 120 may be performed by componentry other than the FPGA 124 as shown in FIGS. 1C-1D. For example, the cross-domain guard 120 and/or CDS 112 may further include a controller 128 that includes one or more processors 132, a memory 136, and a communication interface 140. The controller 128 is configured to provide at least partial processing functionality for the CDS 112 and/or the cross-domain guard 120 and can include the one or more processors 132 (e.g., micro-controllers, circuitry, field programmable gate array (FPGA), central processing units (CPU), application-specific integrated circuit (ASIC), or other processing systems), and resident or external memory 136 for storing data, executable code, and other information. The controller 128 can execute one or more software programs embodied in a non-transitory computer readable medium (e.g., memory 136) that implement techniques described herein. The controller 128 is not limited by the materials from which it is formed or the processing mechanisms employed therein and, as such, can be implemented via semiconductor(s) and/or transistors (e.g., using electronic integrated circuit (IC) components), and so forth.

The memory 136 can be an example of tangible, computer-readable storage medium that provides storage functionality to store various data and/or program code associated with operation of the controller 128, such as software programs and/or code segments, or other data to instruct the controller 128, and possibly other components of the CDS 112, to perform the functionality described herein. Thus, the memory 136 can store data, such as a program of instructions for CDS 112 and/or the cross-domain guard 120, including its components (e.g., controller 128, communication interface 140, etc.), and so forth. The memory 136 may also store data derived from the CDS 112 and/or the cross-domain guard 120. It should be noted that while a single memory 136 is described, a wide variety of types and combinations of memory 136 (e.g., tangible, non-transitory memory) can be employed. The memory 136 may be integral with the controller 128, may comprise stand-alone memory, or may be a combination of both. Some examples of the memory 136 may include removable and non-removable memory components, such as random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

The communication interface 140 may be operatively configured to communicate with components of the CDS 112 and/or the cross-domain guard 120. For example, the communication interface 140 can be configured to retrieve data from the controller 128 or other components, transmit data for storage in the memory 136, retrieve data from storage in the memory 136, and so forth. The communication interface 140 can also be communicatively coupled with the controller 128 to facilitate data transfer between components of the CDS 112 and the controller 128. It should be noted that while the communication interface 140 is described as a component of the CDS 112, one or more components of the communication interface 140 can be implemented as external components communicatively coupled to the CDS 112 via a wired and/or wireless connection.

FIG. 1E is a block diagram illustrating a detailed view of the cross-domain guard 120 and associated FPGA 124, in accordance with one or more embodiments of the disclosure. The FPGA 124 may include a memory interconnect 144 that sends and/or receives control/monitor data and/or rule data to the filter engine 126 via memory-mapped interfaces (e.g., a control/monitor database memory master 146 and/or a rule processor database memory master 147) that write received databases to operational memory during initialization, monitor database checksums during operation, and/or sanitize operational memory.

In some embodiments, the FPGA 124 may include a random-access memory (RAM) element 148 communicatively coupled to the memory interconnect 144. The RAM element 148 may be configured as a large FPGA-Based RAM that assists with the functionality of the filter engine 126. The RAM element 148 may also be configured as an external memory interface for external random-access memory. For example, the RAM element 148 may be communicatively coupled to a double data rate (DDR) RAM array 152.

In some embodiments, the FPGA 124 further includes and input/output interface (I/O) that includes a media access control (MAC) logic element 156 configured to provide input/output control between the FPGA 124 and a physical layer (PHY) 160. The MAC logic element 156 may be configured to use any networking technology including but not limited to Ethernet, Wi-Fi, and Bluetooth technologies. The MAC logic element 156 may be communicatively coupled to the filter engine 126, where the MAC logic element 156 may send incoming messages from the physical layer 160 to the filter engine 126 via a MAC interface 158 and send processed messages from the filter engine 126 to the physical layer 160.

It should be understood that the I/O interface may be configured as any type or number of logic elements or components. For example, the I/O interface may include PCIe componentry. In another example, data may be sourced or sinked to and/or from other logic blocks that may sit between the I/O interface and one or more filter engines 126 within the same FPGA 124. Therefore, the above description should not be interpreted as a limitation of the present disclosure, but merely an illustration.

The rule database 164 may be communicatively coupled to a serial peripheral interface 168 (e.g., via an input/output interface 167 for communicating data externally of the FPGA 124). For example, the serial peripheral interface 168 may be configured as a quad serial peripheral interface (QSPI).

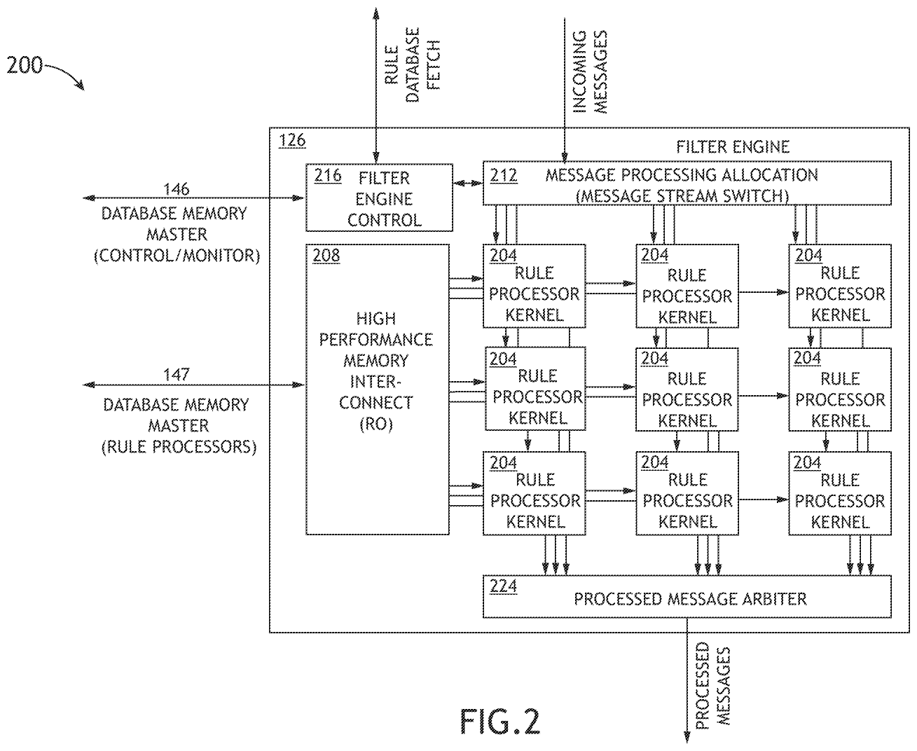

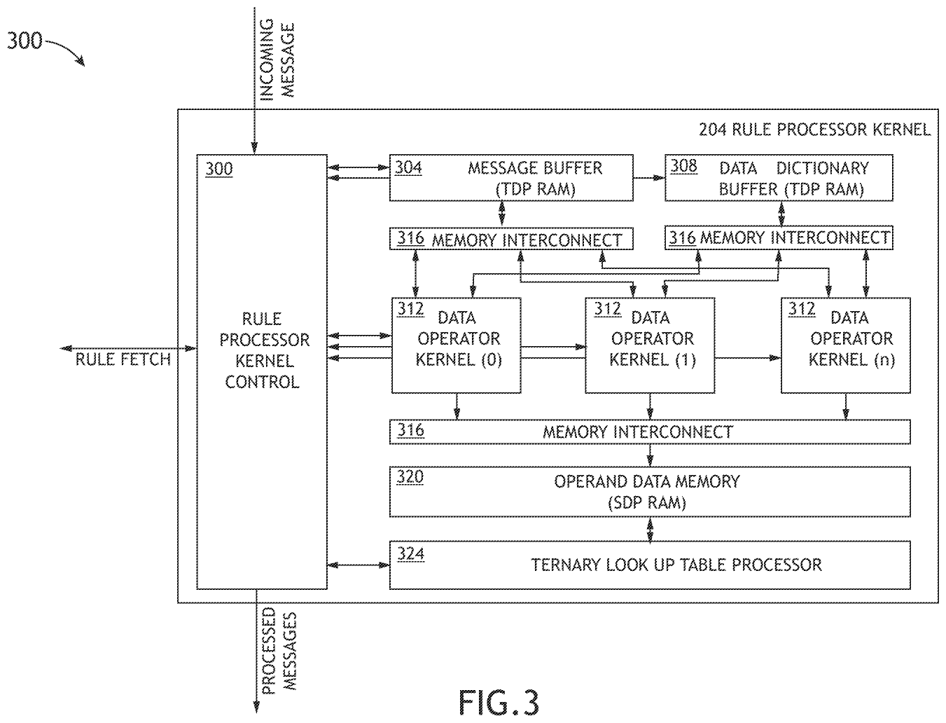

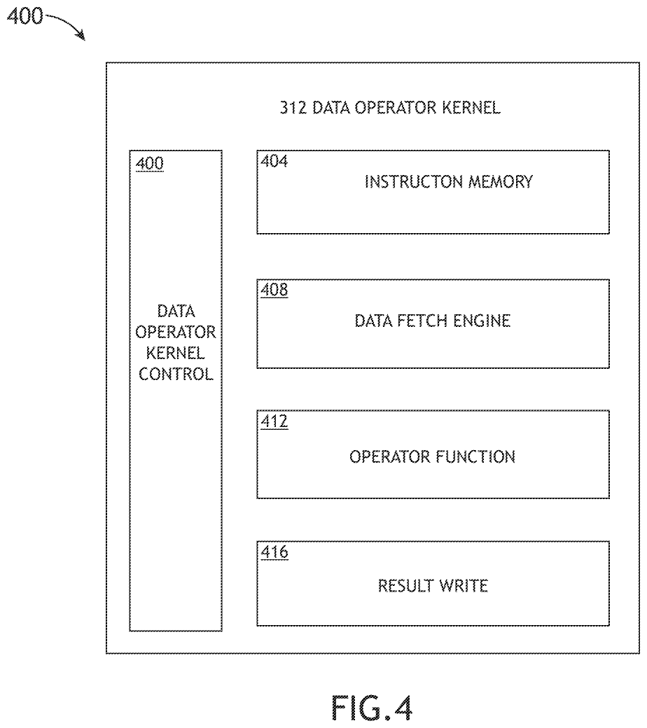

FIG. 2 is a block diagram illustrating a top-tier architecture view of the filter engine 126 in accordance with one or more embodiments of the disclosure (e.g., with a middle-tier architecture view and a bottom-tier architectural view illustrated on FIGS. 3 and 4, respectively). Each tier of the a three-tiered design includes componentry that may be scalable and capable of processing data distributively and/or in parallel. The filter engine 126 may be implemented upon a portion of the FPGA 124, upon the entirety of the FPGA 124, or implemented upon a plurality of FPGAs 124. The FPGA 124 contains programmable control logic elements that perform multiple processing and logic functions required for filtering data via security-based rules.

In embodiments, the filter engine 126 includes a plurality of rule processor kernels 204 configured to perform rule processing operations. For example, one of the one or more rule processor kernels 204 may be configured as a data operator, performing tasks with respect to message data and/or rule-specific comparison data. In another example, one of the one or more rule processor kernels 204 may be configured as a logic operator, processing the ternary result of data operators. The filter engine 126 may include any number of rule processor kernels 204. For example, the filter engine 126 may include one or more rule processor kernels 204. In another example, the filter engine 126 may include ten or more rule processor kernels 204. In another example, the filter engine 126 may include 100 or more rule processor kernels 204. In another example, the filter engine 126 may include 1000 or more rule processor kernels 204. In another example, the filter engine 126 may include 10,000 or more rule processor kernels 204.

In embodiments, the filter engine 126 further includes a high-performance memory interconnect 208 communicatively coupled to the plurality of rule processor kernels 204 and memory 136. For example, the high-performance memory interconnect 208 may be coupled to one or more memory elements on the FPGA 124 (e.g., on-chip memory). In another example, the memory 136 may be configured as a memory component separate from the FPGA 124. The memory 136 may be configured as a database of rules and instructions for the rule processor kernels 204. The high-performance memory interconnect 208 may also perform input/output functions for the FPGA 124.

In embodiments, the high-performance memory interconnect is communicatively coupled to the rule processor database memory master 147. The rule processor database memory master 147 is a standardized read-write capable memory-mapped interface configured to connect to external memory buffer and stores rule databases external to the filter engine 126. The rule processor database memory master 147 may be of any size or number. For example, the rule processor database memory master 147 may be sized according to the number of rules and/or the content of each rule.

In embodiments, the filter engine 126 further includes a message processing allocation element 212 coupled to the plurality of rule processor kernels 204 and configured to manage the allocation of incoming message streams available to the rule processor kernels 204. For example, the message processing allocation element 212 may be configured to break-up incoming messages and data into data segments that may be divided among the plurality of rule processor kernels 204 (e.g., in a distributed or parallel manner).

The filter engine 126 further includes a filter engine control 216 communicatively coupled to the message processing allocation element 212 configured to fetch the rule database and monitor and/or control the memory 136 utilized by the FPGA 124. The filter engine control 216 includes, or is communicatively coupled to, control interfaces configured to send control/status information externally of the filter engine 126 via the control/monitor database memory master 146 The filter engine control 216 may also include a database fetch interface 220 configured to fetch the rule database from storage.

The filter engine 126 further includes a processed message arbiter 224 that receives the output from the plurality of rule processor kernels 204. The processed message arbiter 224 then reassembles the original message, or series of messages, wherein the messages are then sent off to the high-level component 108 or low-level component 104. In this manner, the FPGA 124 utilizes a parallel approach, via the rule processor kernels 204, for processing network traffic, an advantage over software-based filter methods.

FIG. 3 illustrates a rule processor kernel 204, in accordance with one or more embodiments of the disclosure. Each of the rule processor kernels 204 include data transfer elements for communication with filter engine 126 elements and rule processor kernel 204 elements, as well as elements for processing/filtering data. For example, the rule processor kernel 204 includes a rule processor kernel control 300 configured to receive incoming messages from the message processing allocation element 212 and distribute the incoming messages to rule processor kernel 204 elements. The rule processor kernel control 300 may also receive and/or process one or more outputs from one or more rule processor kernel 312, and send the output to the processed message arbiter 224. The rule processor kernel control 300 may also send and/or receive rule data/instruction from the high-performance memory interconnect 208.

In some embodiments, the rule processor kernel 204 includes a message buffer 304 configured to store messages to be processed. The message buffer 304 may comprise true dual-port (TDM) RAM, and may be of any size. For example, the message buffer 304 may be large enough to store at least one message.

In some embodiments, the rule processor kernel 204 includes a data dictionary buffer 308 configured to store constants and other data used for individual rule processing. The data dictionary buffer 308 may comprised TDM RAM and may be of any size. For example, the data dictionary buffer 308 may be configured to store the data set for the largest rule.

In embodiments, the rule processor kernel 204 includes one or more data operator kernels 312. Data operator kernels 312 are configured as the lowest level rule processing/filtering element of the FPGA 124 and are analogous to software data operator functions. Data operator kernels 312 fetch data from the message buffer 304 and data dictionary buffer 308 (e.g., via local memory interconnects 316), process message data as per loaded instructions, and output results to an intermediate memory. In practice, the data operator is implemented as a pattern checker. For example, an incoming message may be compared against a pattern loaded from a rule-specific data dictionary. For instance, the pattern may be convolved against the entirety of the message field. Data operator kernels 312 generally have no data dependencies and multiple data operator kernels 312 may operate in parallel. Data operator kernels 312 may also be individually programmed with specific processing functions.

The rule processor kernel 204 may include any number of data operator kernels 312. For example, the rule processor kernel 204 may include one or more data operator kernels 312. In another example, the rule processor kernel 204 may include ten or more data operator kernels 312. In another example, the rule processor kernel 204 may include 100 or more data operator kernels 312. In another example, the rule processor kernel 204 may include 1000 or more data operator kernels 312. In another example, the rule processor kernel 204 may include 10,000 or more data operator kernels 312.

In some embodiments, the rule processor kernel 204 includes an operand data memory 320 communicatively coupled to the data operator kernel 312 via the one or more local memory interconnects 316. The operand data memory 320 may be configured to store results of the data operator kernel 312. The operand data memory 320 may also be configured to store partial results of a ternary lookup table (e.g., ternary results being true, false, or undefined), particularly if the logic equation is larger than the native capability of the processor.

In some embodiments, the rule processor kernel 204 includes a ternary lookup table processor 324, configured to perform logic operations. For example, the ternary lookup table processor 324 may be configured to process the output of the data operator kernel 312 providing a ternary result (e.g., true, false, undefined) based on the data operator kernel output and a loadable lookup table.

FIG. 4 is a block illustration of the data operator kernel 312, in accordance with one or more embodiments of the disclosure. As mentioned previously, the data operator kernel 312 is the lowest level processing element, operating as a simple fixed-function pipelined processor. Each data operator kernel 312 implements individual functions that may be independent of other operation functions of other data operator kernels. For example, each data operator kernel 312 may have a unique instruction set architecture (ISA).

In some embodiments, the data operation kernel 312 includes a data operator kernel control 400. The data operator kernel control facilitates aspects of data processing by the data operation kernel 312 including but not limited to loading of instructions, controlling run-time of the data operation kernel 312, and reporting execution status of processes within the data operation kernel 312.

In some embodiments, the data operator kernel 312 may further include instruction memory 404 configured to store fetched processing instructions. The instruction memory 404 may be configured within the boundary of the data operator kernel 312 or outside the boundary of the data operator kernel 312. For example, the instruction memory 404 may be defined as a separate element within the rule processor kernel 204 that is communicatively coupled to the data operator kernel 312 and/or other logical operators.

In some embodiments, the data operator kernel 312 further includes a data fetch engine 408. The data fetch engine 408 is configured to receive input instruction and output data that is to be operated upon downstream within the data operator kernel 312. For example, the data fetch engine 408 may fetch data from the memory buffer 304 and/or the data dictionary buffer 308, and output resultant opcode. The data fetch engine 408 is configurable based on the number of required arguments.

In some embodiments, the data operator kernel 312 further includes an operator function element 412 configured to implement the operation function of the data operator kernel 312. For example, the operator function element 412 may receive an input in the form of data or opcode from the data fetch engine 408 and output a ternary result (e.g., true, false, or undefined).

In some embodiments, the data operator kernel 312 further includes a result write element 412. The result write element 412 is configured to generate a write request to intermediate memory may include output data obtained from the operator function element 412.

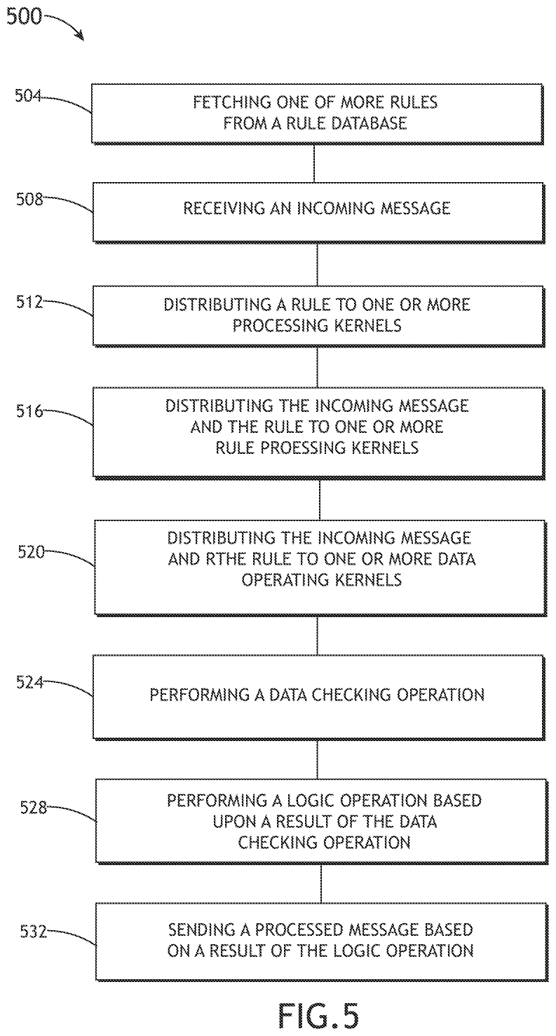

FIG. 5 is a flowchart illustrating a method 500 for filtering incoming messages between network components (e.g., the low-level component 104 and/or high-level component 108) having different privileges (e.g., different security levels), in accordance with one or more embodiments of the disclosure. The method 500 involves comparing messages against user-defined rules to determine if the message may be transferred between components having different security levels. These user-defined rules may also determine if a message has been processed or not, and in some cases, only one rule applies to a given message. The method 500 utilizes the componentry of the FPGA 124 and filter engine 126 as described herein.

In some embodiments, the method 500 includes a step 504 of fetching one or more rules from the rule database 164. The rule database 164 contains one or more filtering rules to apply against incoming messages. For example, the filter engine 126 may fetch one or more rules upon initialization from the rule database 164.

In some embodiments, the method 500 includes a step 508 of receiving an incoming message. For example, the message processing allocation element 212 may receive an incoming message from the MAC logic element 156. The incoming message may be of any size, number or type.

In some embodiments, the method 500 includes a step 512 of distributing a rule to one or more rule processor kernels 204. For example, the high-performance memory interconnect 208, may fetch the rule from the rule processor database memory master 147 and/or memory interconnect 144, and relay the rule to one or more rule processor kernels 204 (e.g., the rule processor kernel control 300 within the rule processor kernel 204).

In some embodiments, the method includes a step 516 of distributing the incoming message to the rule processor kernel 204. For example, the message processing allocation element 212 may allocate the incoming message to an available rule processor kernel (e.g., the rule processor kernel control 300 within the rule processor kernel 204). The message allocation element 212 may send a single incoming message, a partial incoming message, or multiple incoming messages to the rule processor kernel 204.

In some embodiments, the method 500 includes a step 520 of distributing the incoming message and rule to one or more data operator kernels 312. For example, the incoming message may be sent directly from the rule processor kernel control 300 to one or more data operator kernels 312 (e.g., to the data fetch engine 408). In another example, the rule may be sent directly to one or more data operation kernels 312 (e.g., to the instruction memory 404). In another example, the incoming message may be sent to the message buffer 304, and relayed to one or more data operator kernels 312 via a local memory interconnect 316 and/or data dictionary buffer 308.

In some embodiments, the method 500 includes a step 524 of performing a data checking operation. For example, the operator function element 412, having received the incoming message from the data fetch engine 408 and the rule from the instruction memory 404, may apply a data checking operation upon the incoming message based on the rule. The result of the data checking operation may be temporarily written to the result write element 416 and or operand data memory 320. This performance of the data checking operation may be executed in parallel, via the one or more rule processor kernels and/or the one or more data operator kernels 312.

In some embodiments, the method 500 includes a step 528 of performing a logic operation based upon the result of the data checking operation. For example, the result of the data checking operation may be sent to the ternary lookup table processor 324. The ternary lookup table processor 324 will implement a ternary lookup table (e.g., a loadable lookup table) and determine, utilizing logic, a logic result of the data checking operation (e.g., true, false, or undetermined).

In some embodiments, the method 500 includes a step 532 of sending a processed message based on the result of the logic operation. For example, if the logic operation determines that the incoming message is valid (e.g., true), then the incoming message will be sent to the processing message arbiter 216, and subsequently outputted to the MAC logic element 156. In another example, if the logic operation determined that the incoming message is not valid (e.g., false), then the incoming message will not be subsequently sent to the MAC logic element 156, and the result may be reported via the high-performance memory interconnect 208 or filter engine control 216.

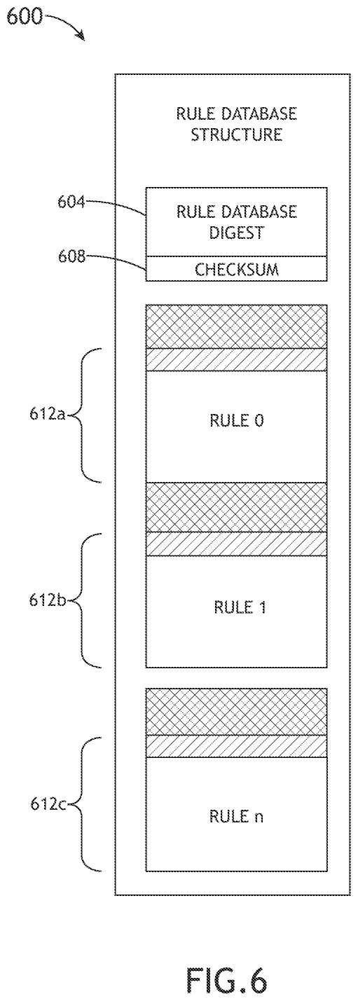

FIG. 6 is a block diagram of a rule database structure 600 utilized by the filter engine 126, in accordance with one or more embodiments of this disclosure. The rule database structure 600 includes a database digest 604, which contains a rule identification (ID), rule container offset information, as well has a checksum for a rule container. The database digest 604 also includes a database digest checksum 608. The database digest also contains one or more rules 612a-c. The database digest 604 is loaded into each individual rule processor kernel 204 at initialization.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a cross-domain guard, comprising:
a field programmable gate array comprising:
a rule database containing one or more rules,
a memory interconnect configured to send at least one of control data or rule processing data;
media access control logic; and
a plurality of filter engines configured to receive an incoming message and generate a processed message, wherein one or more of the plurality of filter engines comprises;
a message processing allocation element configured to receive and distribute the incoming message;
a plurality of rule processor kernels, and
a processed message arbiter.

2. The system of claim 1, wherein one or more of the plurality of rule processor kernels comprises;
a rule processor kernel control element;
a plurality of data operator kernels configured to perform a data comparison operation; and
a ternary lookup table processor configured to perform a logic operation based upon a result of the data comparison operation.

3. The system of claim 2, wherein one or more of the plurality of data operator kernels comprises:
a data operator kernel control;
an instruction memory configured to store the one or more rules;
a data fetch engine configured to fetch message data;
an operator function element configured to perform the data comparison operation based on the one or more rules and the message data; and
a result write element.

4. The system of claim 1, wherein the plurality of filter engines are configured to operate independently and in parallel to each other.

5. The system of claim 1, wherein the plurality of rule processor kernels are configured to operate independently and parallel to each other.

6. The system of claim 2, wherein the plurality of data operator kernels are configured to operate independently and parallel to each other.

7. The system of claim 1, wherein the one or more of the rule processor kernel further comprises a message buffer.

8. The system of claim 1, wherein the one or more of the plurality of rule processor kernels further comprise a data dictionary buffer configured to store constants used for rule processing.

9. The system of claim 1, further comprising a high-level component and a low-level component.

10. A method for filtering an incoming message between network components having different privileges comprising:
Fetching one or more rules from a rule database;
Receiving the incoming message;
Distributing the rule to one or more rule processor kernels;
Distributing the incoming message to the one or more rule processor kernels;
Distributing the incoming message and the rule to one or more data operator kernels;
Performing a data checking operation;
Performing a logic operation upon a result of the data checking operation; and
Sending a processed message based on a result of the logic operation.

11. The method of claim 10, wherein the method is performed by a cross-domain guard.

12. The method of claim 11, wherein performing the data checking operation and performing the logic operation is performed via a field programmable gate array.

13. The method of claim 10, wherein the different privileges are configured as different security levels.

14. The method of claim 10, wherein the network components are configured as a high-level component and a low-level component.

15. The method of claim 10, wherein the performing the data checking operation is executed in parallel.
